(19) United States
(12) Patent Application Publication
(10) Pub. No.: US 2009/0115159 A1
(43) Pub. Date: May 7, 2009

(54) ARRANGEMENT FOR TELESCOPIC FORK LEG WITH PARALLEL DAMPING

(75) Inventor: Torkel Sintorn, Vaxholm (SE)

Correspondence Address: KNOBBE MARTENS OLSON & BEAR LLP, 2040 MAIN STREET, FOURTEENTH FLOOR, IRVINE, CA, 92614, US

(73) Assignee: OHLINS RACING AB, Upplands Vasby (SE)

(21) Appl. No.: 12/263,137

(22) Filed: Oct. 31, 2008

Related U.S. Application Data
(63) Continuation-in-part of application No. 12/090,337, filed on Sep. 24, 2008.

(30) Foreign Application Priority Data
Oct. 19, 2005 (SE) 0502310-6

(51) Int. Cl. B62K 25/06; B60G 17/04

(52) U.S. Cl. 280/276

(57) ABSTRACT

A device for telescopic fork legs, preferably for a motorcycle or bicycle. The device is a compact removable unit that comprises parallel medium flow passages that run between upper and lower sides of the piston. This unit that is simple to adapt to different front fork dimensions and to use as a kit for providing an existing front fork with parallel damping. Parallel damping achieves simple adaptation of the damping characteristics to different types of terrain.

### CROSS-REFERENCE TO RELATED APPLICATIONS

This application is a continuation-in-part of U.S. patent application Ser. No. 12/090,337, filed on Apr. 15, 2008, which is the U.S. National Phase of International Application No. PCT/SE2006/001187, filed Oct. 18, 2006, which is based upon Swedish Patent Application No. 0502310-6, filed Oct. 19, 2005, each of which is hereby incorporated by reference in its entirety and priority is claim to each of these applications.

### BACKGROUND OF THE INVENTION

1. Field of the Invention

The present invention relates to a device for telescopic fork legs, preferably on a motorcycle or bicycle, where the telescopic fork leg comprises outer and inner legs and a damping system with a piston and piston rod arrangement that is arranged within these.

2. Description of the Related Art

A front fork for a motorcycle or a bicycle can be subjected to wheel speeds in the range of 0-10 m/s and stroke lengths of up to 300 mm. In order to be able to absorb such high speeds and such large strokes, great demands are made of the front fork. It must be able to absorb forces and be strong, while at the same time it must be able to handle a large flow of oil. It is also desirable to have good control in the whole range of speeds and for the damping to be adjustable. A compact and light system that can be adapted to fit several different front fork dimensions also is desired. Reference is made, for example, to patent U.S. Pat. No. 6,260,832, that shows a front fork of the type described above. U.S. Pat. No. 6,260,832 does not, however, have the desirable build-up of pressure that is described below.

Current systems can be represented by a damper of the De Carbon type, see for example FR1055443A, and have a serial damping force construction that is based on a principle of pressurizing two locations in series in order to avoid cavitation or the admixture of air into the damping medium. This system has limitations in that the pressures in the two pressurizing locations must more or less harmonize with each other, as the drop in pressure (ΔP1=Plow−Pmid, ΔP2=Pmid−Pgas) across the two pressurizing pistons should be greater than zero in order not to create cavitation. See FIG. 1. Because the drop in pressure across the piston is dependent upon the flow resistance through the piston in combination with the force that acts on the piston, the flow resistance, controlled for example by a shims stack, can only be adjusted within a certain limited range, which thus also results in a limited area of use for the damper. It is then also necessary to dimension pistons, piston rods and damping tubes so that the force absorption agrees with the pressures that have been built up, in order to obtain the required damping. With serial damping, the oil is forced through both of the valves in series, which results in high flow speeds. With high flow speeds and high piston speeds, the design of the pistons is limited in order not to obtain an unwanted uncontrolled build-up of pressure due solely to the flow resistance.

A system with parallel damping solves the abovementioned problem. Examples of such dampers can be found in the patent documents EP1505315A2 and EP0322608A2. The parallelism in the damping arises through the damping medium being pressurized by two pressurizing pistons that are arranged parallel to each other in the damping chamber and in a space arranged outside the damping chamber. The pressurized outer space is interconnected with both the compression chamber and the return chamber. With parallel damping, the pressure on the low-pressure side of the damping piston is always as large as possible, irrespective of whether the front fork is subjected to a compression or a return stroke. The definition of the low-pressure side of the damping piston is the side of the piston where the volume of the chamber increases. Due to the fact that the pressure is never allowed to become zero on that side, cavitation is prevented. This parallel arrangement also means that the damper can be pressurized and the pressure, that is the damping, can be adjusted without having to take into account the drop in pressure across the piston(s). The increase in pressure, as well as the increase in force, now takes place without cavitation, irrespective of the setting.

### SUMMARY OF THE INVENTION

The designs according to EP1505315A2 and EP0322608A2 are adapted for shock absorbers that are not subjected to the same forces and impacts as a front fork. A device is thus required for a front fork that comprises adjustable parallel damping. It is also advantageous if the device is able to be adjusted to suit different front fork dimensions and can be used as a kit for modifying an existing front fork.

A telescopic fork leg that is arranged and configured in accordance with certain features, aspects and advantages of some embodiments of the present invention may comprise an outer and an inner leg and a damping system arranged within these. The damping system comprises damping system components that are acted upon by the flow of medium caused by the compression and expansion movements of the main piston. The damping system components together form a compact unit that comprises parallel medium flow passages for the flow between the upper and lower sides of the main piston and the flow that is caused by the pressurizing device that pressurizes the whole damping system. The medium flow passages are arranged parallel to each other in order to ensure low flow speeds between the said sides of the main piston and thereby prevent the uncontrollable build-up in pressure and force on the sides of the piston as a result of the rapid movements and large strokes of the front fork. In each damping system component, the flow through one or both of the respective medium flow passages can be arranged so that it can be adjusted or selected by means of devices, for example valves, in order to achieve, for example, matching of the damping characteristics to different types of terrain, by means of an exceptionally wide range of settings. This wide range of settings is achieved by the medium flow passages comprising separate connections to a common pressure build-up location where the pressure is created by the abovementioned pressurizing device.

In accordance with certain features, aspects and advantages of some embodiments of the present invention, the damping system components comprise two concentric tubes in the form of a damping tube and an outer tube that is arranged around the damping tube. The tubes together form a portion of a removable insert system in the front fork. The insert system creates a double tube function in which the damping medium can flow in parallel as a result of the duct between the damping tube and the outer tube being used to connect together the two chambers and the common pressurizing location. The pressurizing location is connected to the medium flow passages between the damping cylinder and the outer tube via a head that also comprises valves for adjusting the flow of the medium. This insert system forms a compact unit that is simple to adapt to different front fork dimensions and that can also be used as a kit for providing an existing front fork with parallel damping.

### BRIEF DESCRIPTION OF THE DRAWINGS

These and other features, aspects and advantages of the present invention will now be described with reference to the drawings of some preferred embodiments, which embodiments are intended to illustrate and not to limit the invention.

FIG. 1 shows a damper according to previously-known technology (De Carbon)

FIG. 2 shows a front fork mounted on a vehicle

FIG. 3 shows a view of the front fork in cross section

FIG. 4 shows a detail view of a lower part of the front fork

FIG. 4a shows a detail view of a hydraulic stop

FIG. 5a shows a simplified view of the front fork in cross section with arrows illustrating the flow during a compression stroke

FIG. 5b shows a simplified view of the front fork in cross section with arrows illustrating the flow during a return stroke

FIG. 6 shows another embodiment of the front fork with internal pressurized bellows as a pressurizing device.

FIG. 6a is a detail view of a pressurizing device in the form of a movable piston pressurized by gas.

FIG. 6b is a detail view of a pressurizing device in the form of a movable piston pressurized by a spring.

FIG. 7 shows another embodiment of the front fork.

FIG. 7a is a top plan view of the front fork of FIG. 7.

FIG. 7b is a section through an upper portion of the front fork, taken along the line L-L in FIG. 7a.

FIG. 7c is a section through the upper portion of the front fork, taken along the line J-J in FIG. 7a.

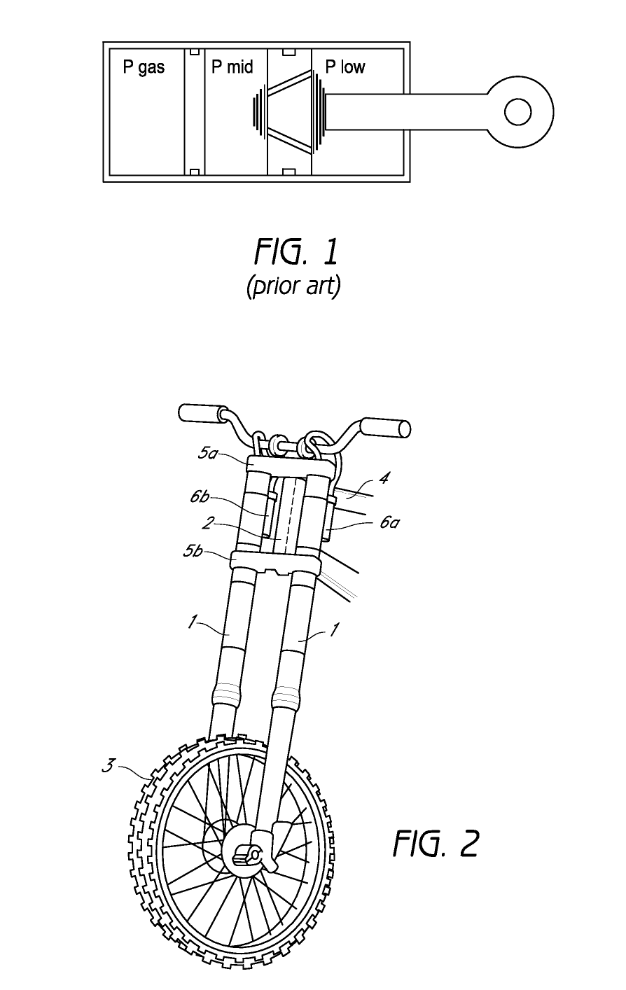

### DETAILED DESCRIPTION OF THE PREFERRED EMBODIMENT

FIG. 2 shows a front fork mounted on a vehicle, in this embodiment a motorcycle, of which only the front part is shown. Fork legs (1) are arranged on each side of a steering pillar (2). Lower portions of the fork legs (1) are attached to a wheel (3) and upper portions are connected to the frame (4) via a top yoke and a bottom yoke (5a, 5b). According to this embodiment, each fork leg (1) of the front fork has an external pressure chamber (6a, 6b) that is attached to the respective fork leg (1). The pressure chamber can be mounted in other locations, such as, for example, in the yoke, in the frame or on the steering pillar. Moreover, as will be discussed, the pressure chamber can be positioned within the fork leg itself in some embodiments.

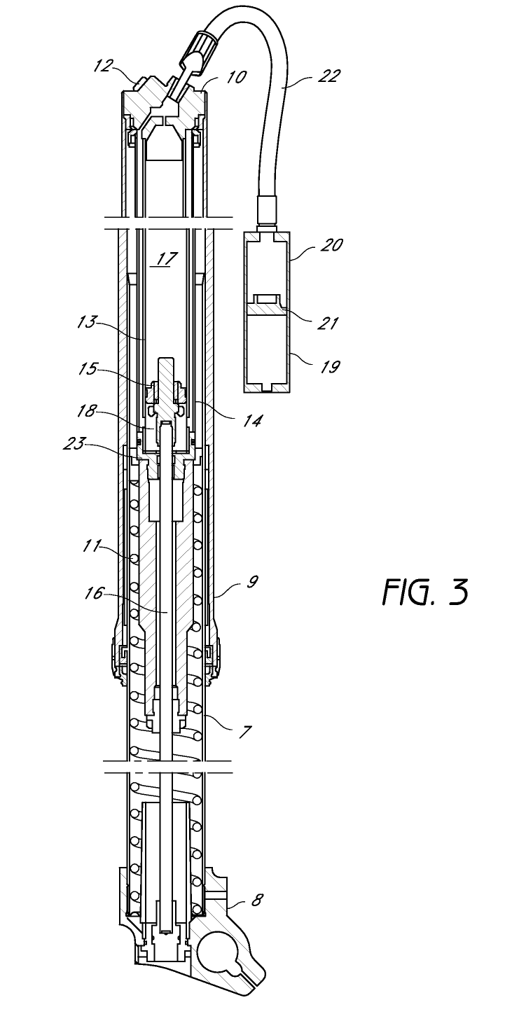

FIG. 3 shows an embodiment of the front fork (1) in cross section and its construction and function are described below in greater detail. The front fork (1) comprises a lower inner leg (7) arranged on a bottom unit (8) and an upper outer leg (9) that terminates in a head (10) that seals the fork. A spring (11) is arranged in the lower inner leg (7) and a damping system is arranged in the upper outer leg (9).

The illustrated damping system is constructed of a damping tube (13) and an outer tube (14) that together create a double tube construction that contributes to parallel flow. A shimmed damping piston (15) is arranged in the damping tube (13) on a piston rod (16), which piston (15) divides a damping chamber into a return chamber (18) and a compression chamber (17). During movement of the piston (15), the return chamber (18) and the compression chamber (17) alternate in being the high-pressure and low-pressure side.

At the upper end of the front fork, opposite to the bottom unit (18), the double tube (i.e., the damping tube (13) and the outer tube (14)) is attached to the sealed-off head (10) that comprises valves (12, 12′). The valves (12, 12′) can be used to adjust the pressure in the damping system to take into account both high and low speeds and both compression and return strokes. The valves (12, 12′) are connected via separate connectors to a common pressurizing location, which can comprise comprising a pressurizing device (19). In this embodiment, the pressurizing device (19) is a container (20) divided by a piston (21) and pressurized by gas. A hose (22) can be coupled (e.g., with a threaded coupler) to one end of the container (20). In the illustrated embodiment, the hose (22) connects together the container (20) and the head (10) of the front fork.

The damping tube (13) and the outer tube (14) together with the head (10), a tube end (23) and the pressurizing device (19) form an insert system that is simple to assemble and compact in size. The insert system can be adapted to be mounted in existing front forks on many different types of vehicles in order to obtain, in a simple way, a system with the advantages of parallel damping without having to buy a completely new product. With the compact insert system, it is also easy to dismantle and service the product.

One end of the piston rod (16) is attached to the bottom unit (8) on the front fork and the piston (15) is mounted at the other end. The piston rod (16) preferably is sealed against, and extends through, the tube end (23) of the insert system.

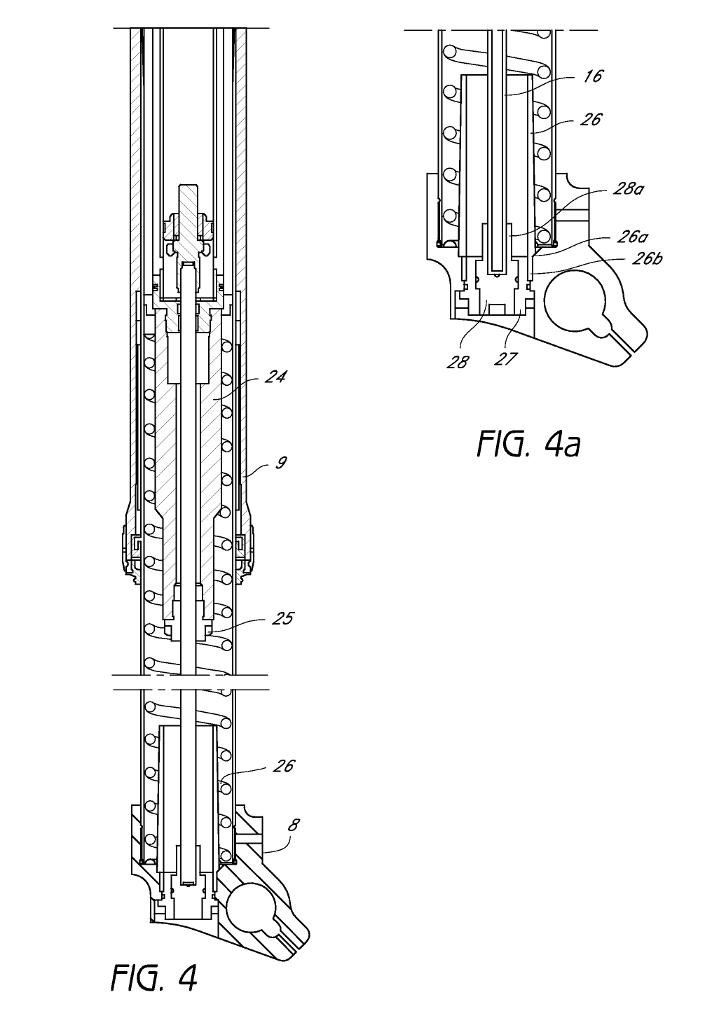

FIG. 4 shows an enlarged partial view of the lower part of the front fork. In order to support the piston rod (16) at the joint, a spring support (24) is arranged around the piston rod (16). The spring support (24) fulfills two functions: giving the piston rod (16) an extra point of support and providing a low-friction surface for the spring (11) to move against.

A metallic part (25) is arranged at the end of the spring support (24). This part (25) interacts with (i.e., can be inserted into) a cylindrical part (26) that is attached to the bottom unit (8), in such a way that a hydraulic stop is created, which reduces the likelihood of the front fork bottoming in the event of unusually strong compression.

The fact that the insert system is easy to dismantle from the front fork is also illustrated by FIG. 4a, which shows the lower part of the front fork. The figure shows that the lower part (26a) of the cylindrical part (26) of the hydraulic stop is pressed into the bottom unit (8) of the front fork by pressure force. A thread (26b) is arranged in the internal diameter of the hydraulic stop, so that a bottom part (27) can be screwed into the thread (26b). The bottom part (27) also comprises a seal (28) that reduces the likelihood of leakage from the front fork. The bottom-most part of the bottom part (27) is designed to be able to be attached, or to be screwed in and out, using a hexagonal key so that the front fork is easy both to assemble and to dismantle. A piston rod holder (28a) can be integrated with the seal (28) that is threaded into the bottom part (27). The piston rod (16) can be attached in a recess in the piston rod holder (28a) and the other part of the holder (28a) can be screwed down from above into the abovementioned bottom part (27). Because the holder (28a) can be screwed out of the bottom part (27), the illustrated front fork is simple to dismantle by withdrawing the whole insert in an upward direction.

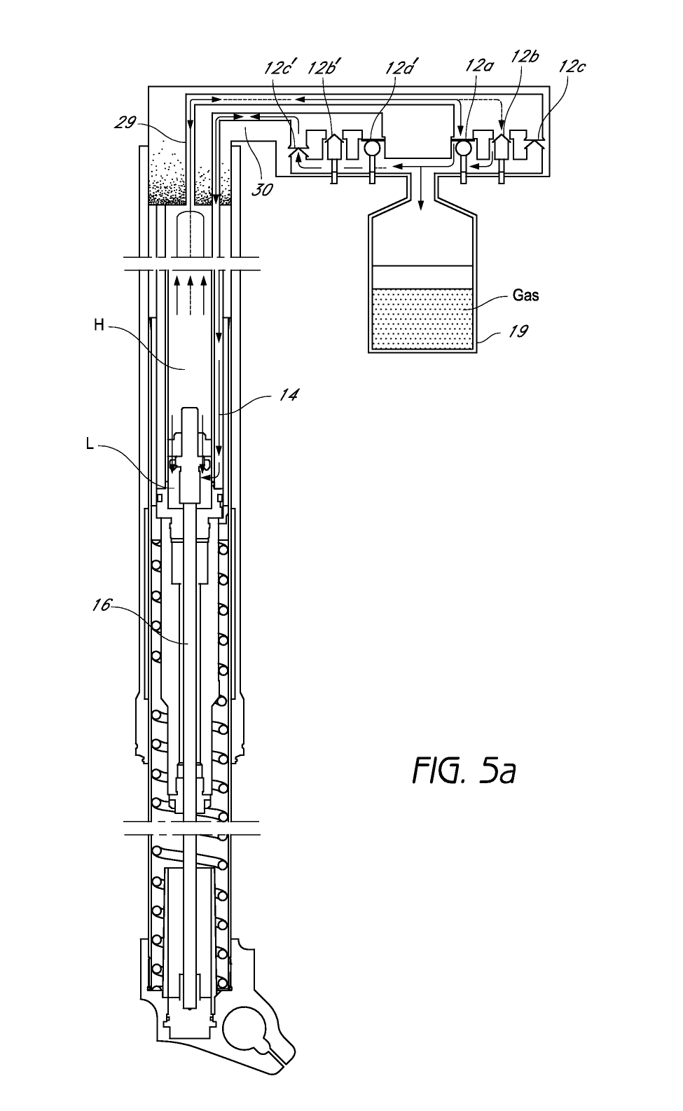

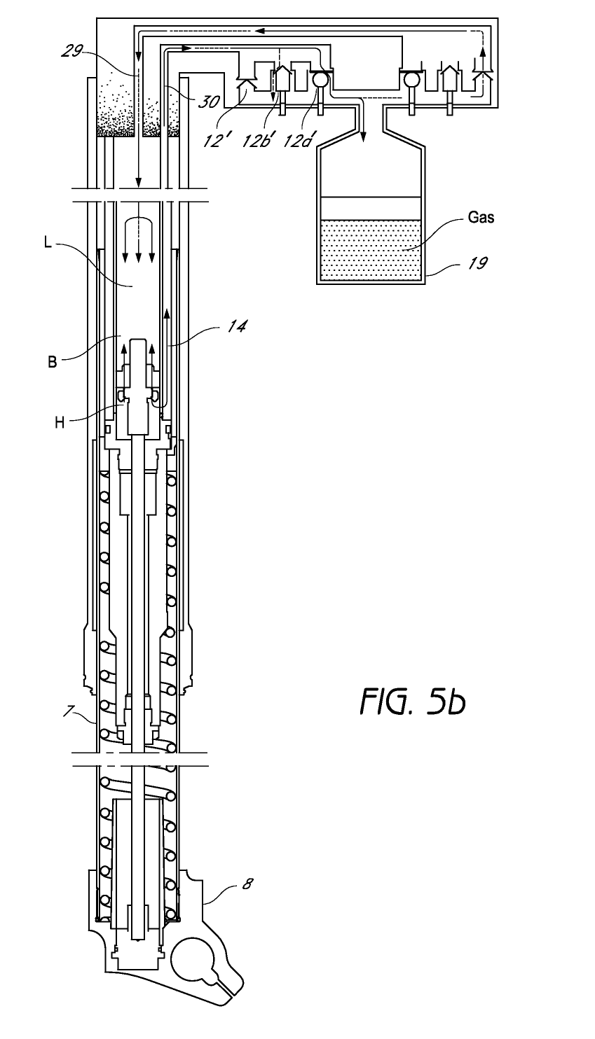

FIGS. 5a and 5b show flow in the front fork through different medium flow passages (29, 30) and through flow areas that are adjusted by valves (12a, 12b, 12a′, 12b′). The valves comprise high-speed valves (12a, 12a′), low-speed valves (12b, 12b′) and standard non-return valves (12c, 12c′). The different types of valve are already well known and will not be described in greater detail. The medium flow passages (29, 30) are arranged in such a way that they are parallel in relation to each other and are connected to the common pressurizing location, which comprises the pressurizing device (19) in the illustrated configuration. Because the passages (29, 30) are parallel, the flow is divided between the two medium-flow passage areas and the flow speeds in the system can essentially be reduced, for example halved, in relation to the actual speed of the longitudinal displacement movements. The flow speed in the medium is determined by the frequency of the movements, or the size of the impacts, With a lower flow speed, the likelihood is greatly reduced of uncontrolled build-up of pressure and forces that can otherwise arise in the system.

The high-pressure and low-pressure sides of the damper change with the direction of the stroke. As a result of the flow paths (29, 30) and the position of the valves (12, 12′), the pressure on the low-pressure side is always as high as possible and the likelihood of cavitation is greatly reduced.

During a compression stroke (see FIG. 5a), the damping medium flows through the damping system as shown by the flow arrows in the figure. The solid arrows represent the compression flow when the front fork is subjected to a force with high speed and the broken arrows represent the compression flow when the speed of the force that is applied is low. That is, at high speeds, when parts of the damping medium on the high-pressure side (H) are pressurized by the shimmed piston (15), the remaining quantity of medium flows via a passage (illustrated in a simplified form by (29)) in the head (10) through the adjustable high-speed valve (12a) and the non-return valve (12c′) through the space between the tubes (13 and 14) to the other side, that is the low-pressure side (L), of the piston. At low speeds that do not cause sufficient pressure to open the shim stack and the high-speed valve, the medium flows via the adjustable low-pressure valve (12b) via the same non-return valve (12c′) to the low-pressure side (L). Pressurizing of the medium, by means of the pressurizing device (19), takes place parallel with the flow. The medium that is displaced by the piston rod (16) can be taken up by the container (20) or any other component, mechanism or volume that acts as a pressurizing device (19).

During a return stroke, FIG. 5b, the damping medium flows according to the same principle but in the opposite direction to the compression direction described above, according to the flow arrows shown in FIG. 5b. The flow is thus partially directed straight through the piston (15) from the high-pressure side (H), and partially up through the space between the tubes (13, 14), via the passage (30) in the head (10), through the valve (12a′ or 12b′) dependent upon high or low speed, through the non-return valve (12c) and then on to the low-pressure side (L) of the piston (15). Pressurizing of the medium is also carried out here parallel with the flow.

As the compression and return adjustments are separated, the valves (12a, 12a′, 12b, 12b′) can be adjusted independently of each other. The pressure therefore can be controlled in such a way that the build-up is greatest during the return or compression stroke, depending upon the external circumstances. The damping characteristics can thus be maximally adapted to suit the terrain, as a result of the large range of adjustment that the valves (12a, 12a′, 12b, 12b′) now have. The large range of adjustment of the valves (12a, 12a′, 12b, 12b′) means an adjustment of the medium flow area from anywhere between maximal and minimal area depending upon the damping force characteristics that are desired.

With parallel passages (29, 30) described above, the flow speed to a specific valve also can be reduced if the pressure on this valve becomes critically high. As the damping medium will take the easiest path (the lowest pressure) in the system, this adjustment capability means that a wide range of pistons (15) and pressurizing devices (19) can now be utilized. An advantage of this is that larger pistons can be used and, with larger pistons, the pressure does not need to be so high in the system and the damper has a smoother characteristic. By a smoother characteristic is meant that the increase in pressure, and also the increase in force, can take place without cavitation, irrespective of the setting.

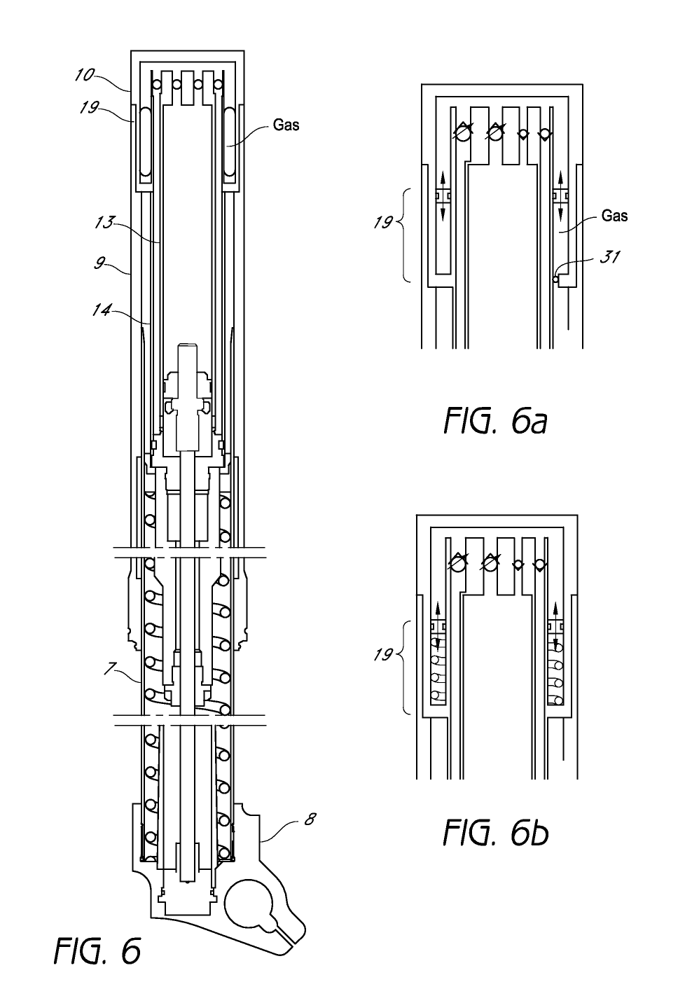

FIG. 6 shows another configuration that is arranged and configured in accordance with certain features, aspects and advantages of some embodiments of the invention. The configuration illustrated in FIG. 6 preferably does not use an external pressurized container. In the illustrated embodiment, the front fork also comprises a lower inner leg (7) arranged on a bottom unit (8) and an upper outer leg (9) terminating with a head (10) that is sealed against the fork and upon which head the damping system is arranged. The valves (12, 12′ (here drawn in a simplified way)) are arranged in the sealed head (10) and ducts in the head interconnect the pressurized spaces. The illustrated damping system is constructed of a damping tube (13) and an outer tube (14) that together form a double tube. A pressurizing part (19), for example a floating piston or bellows, can be arranged in a divided space outside the outer tube (14). The pressurizing part can comprise a piston that is pressurized by a volume of fluid (FIG. 6a), a spring (FIG. 6b), an elastic member or an expandable bellows (FIG. 6), for example but without limitation. The pressurizing part absorbs the volume of damping medium that the piston rod (16) displaces during maximal compression. The reverse side of the floating piston is pressurized by gas (FIG. 6a), a spring (FIG. 6b) or the like and the bellows are pressurized by a compressible gas or the like. Because the whole damping unit can be removed, the gas pressure that pressurizes the damper can also be adjusted in a simple way, for example by having a filling valve (31) connected to the divided space or to the interior of the bellows (not shown). The bellows (see FIG. 6) can, for example, be in the shape of a toroid that is sealed against the surroundings or a cylinder sealed against any one of the double tubes. As the pressurization of the illustrated front fork does not use of an external container, the front fork is easier to assemble and takes up less space.

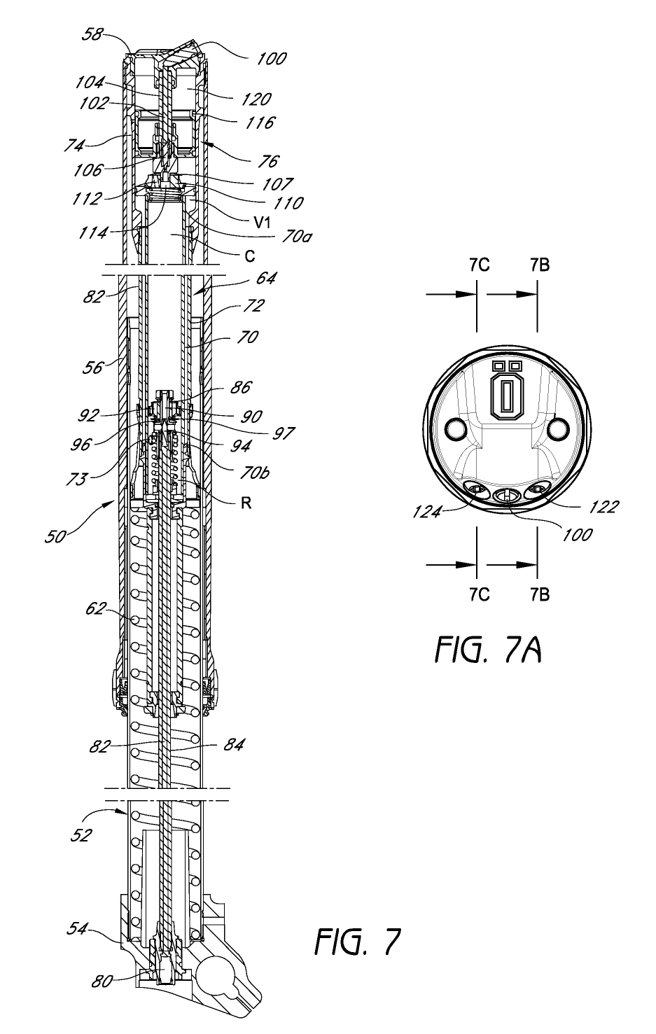

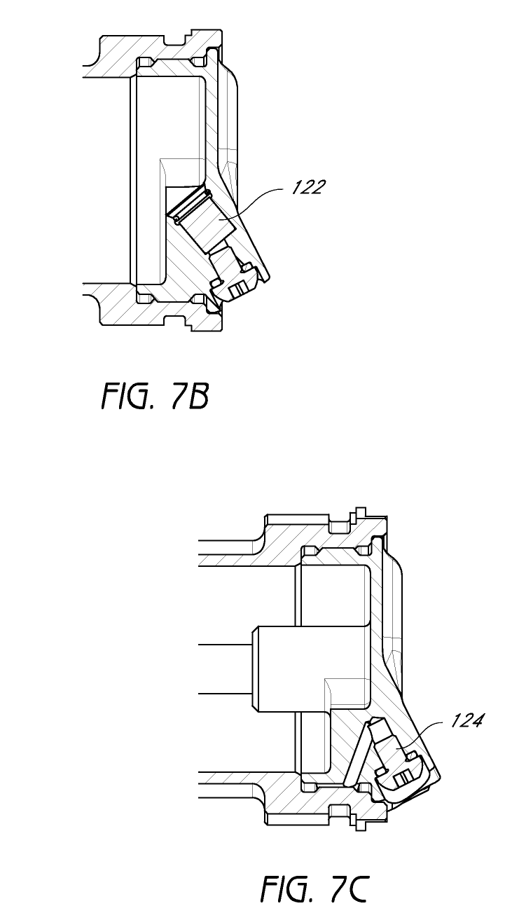

FIG. 7 illustrates another configuration of a front fork (50). The front fork (50) is illustrated in cross section in FIG. 7. The illustrated front fork (50) comprises a lower inner leg (52) that is connected to a bottom unit (54). The illustrated front fork (50) also comprises an upper outer leg (56) that is connected to a head unit (58). A spring (62) is positioned within the lower leg (52). The spring (62) preferably biases the bottom unit (54) away from the head unit (58).

A damping system (64) is arranged within the fork (50). The damping system (64) generally comprises a damping cylinder (70) and a stroke moveable first piston (86) that are both positioned within an outer damping tube (72). A rebound chamber (R) can be defined within the damping cylinder (70) below the illustrated first piston (86). A compression chamber (C) can be defined within the damping cylinder (70) above the illustrated first piston (86). In other words, the first piston (86) separates the damping cylinder (70) into the rebound chamber (R) and the compression chamber (C).

The outer damping tube (72) can be secured to a cartridge outer tube (74). A pressurizing location (V1) can be defined by at least two regions of the illustrated construction. In the illustrated construction, the pressurizing location (V1) comprises the region generally above the damping cylinder (70) within the cartridge outer tube (74) and the region radially outside of the damping cylinder (70) within the outer damping tube (72). Thus, at least a portion of a pressurizing device (76), which is at least partially defined by the cartridge outer tube (74), is positioned generally above the damping cylinder (70), while another portion of the pressurizing device (76) is positioned radially outside of the damping cylinder (70). Moreover, the pressurizing device (76) is positioned inside of the front fork (50) and, in the illustrated embodiment, inside of the outer leg (56). By placing the pressurizing device (76) in the outer leg (56), a more compact design can be achieved. Moreover, such a configuration reduces or eliminates narrow channels used to connect the pressurizing device (76) to the front fork, which reduces or eliminates flow restrictions compared to external pressure cylinder constructions.

A flow opening (73) can be defined through a lower portion (70b) of the damping cylinder (70). The flow opening (73) preferably has the form of at least one hole arranged in the lower part of the damping cylinder (70). The hole (73) places the rebound chamber (R) and the pressurizing location (V1) in fluid communication.

The pressurizing device (76) is pressurizing a pressurizing location (V1) common to the medium flow passages. Due to the flow contact between the pressurizing location (V1) and both sides of the first piston (86) (i.e., both the compression chamber (C) and the rebound chamber (R)) the pressure on the low-pressure side of the first piston (86) always as high as possible and the likelihood of cavitation is greatly reduced.

With reference still to FIG. 7, a rebound valve control (80) is mounted in the bottom unit (54). The rebound valve control (80) can be used to adjust rebound damping characteristics. A rebound adjustment shaft (82) is connected to the rebound valve control (80). Preferably, the rebound adjustment shaft (82) extends through a hollow piston shaft (84).

The first piston (86) is preferably connected to the hollow piston shaft (84). The illustrated piston (86) has at least two separate flow openings (90, 92). The separate flow openings (90, 92) enable hydraulic flow from the rebound chamber (R) to the compression chamber (C). The flow through the first flow opening (90) can be controlled by an adjustment shaft (94) having a cone-shaped end piece while the flow through the second flow opening (92) can be controlled by shims (e.g., flexible, bendable discs) 97 or the like.

The adjustment shaft (94) can be connected to, or in contact with, the rebound adjustment shaft (82). Movement of the rebound adjustment shaft (82) results in movement of the cone-shaped end of the adjustment shaft (94) toward or away from a corresponding valve seat (96). Thus, the hydraulic flow through the first flow opening (90) can be controlled from the rebound valve control (80) and, by changing the position of the shaft (94) that is positioned within the hollow piston shaft (84) in relation to the hydraulic passage (90) through the piston (86), rebound adjustments can be made. The first flow opening (90) can be referred to as the rebound bleed opening.

With reference still to FIG. 7, a compression valve control (100) can be mounted in the head unit (58). The compression valve control (100) can be used to adjust compression damping. Thus, the head unit (58) in FIG. 7 comprises the compression valve control (100) that adjusts compression damping while the bottom unit (54) comprises the rebound valve control (80) that adjusts the rebound damping characteristics.

The compression valve control (100) can be connected to a compression adjustment shaft (102). Rotation of the compression valve control (100) relative to the head unit (58) causes relative axial movement between the head unit (58) and the compression valve control (100). The relative axial movement causes respective movement of a compression adjustment shaft (102). The compression adjustment shaft (102) extends through a hollow shaft (104) and is connected to, or in contact with, a needle valve (106).

The needle valve (106) limits the passage of damping media through a valve device (110). The valve device (110) is positioned at one end of the compression chamber C. The valve device (110) provides at least two separate flow openings (112, 114), which are limited by either the needle valve (106) or by shims (e.g., flexible bendable discs) (107) or the like. Hydraulic flow, thus, can occur from the compression chamber C to the rebound chamber R through the valve device (110).

With continued reference to FIG. 7, a pressurizing piston (116) can be arranged to slide along the hollow shaft (104). The pressurizing piston (116) pressurizes the damping medium and preferably is sealed against both the hollow shaft (104) and the cartridge outer tube (74). Pressurizing media, such as gas, can be infused into a gas chamber (120) above the pressurizing piston (116) through a second valve (122). See FIGS. 7a and 7b. In order to depressurize the illustrated configuration, another valve (124) can be provided. In the illustrated configuration, the valves (122, 124) and the gas chamber (120) can be positioned within the head unit (58) or within close proximity thereto.

A parallel flow of damping media between an upper side and a lower side of the first piston (86) (i.e. between the rebound chamber (R) and the compression chamber (C) in the damping cylinder (70)) is possible via the medium flow openings (112, 114, 90, 92, 73) in the upper part (70a) and the lower part (70b) of the damping cylinder (70) and via the radial distance between the damping cylinder (7Q) and outer damping tube (72). Four of the medium flow openings (i.e., two openings (90, 92) arranged in the first piston (86) and two openings (112, 114) arranged in the valve device (110)) communicate with setting devices (94, 97, 106, 107) adapted to control flow characteristics through the medium flow openings (112, 114, 90, 92).

Advantageously, when the whole system is depressurized, the whole cartridge system, including the damping cylinder (70), the damping outer tube (72), the cartridge outer tube (74), the piston shaft (84) and of the related components can be easily removed from the front fork. Thus, the system can be added to preexisting fork constructions, can be easily removed for servicing and can be easily replaced.

Although the present invention has been described in terms of certain embodiments, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A device for telescopic fork legs, wherein the telescopic fork leg comprises outer and inner legs, the device comprising:
a damping system comprising a piston and piston rod arrangement arranged within the inner and outer legs of the telescopic fork leg,
the damping system comprising a removable compact unit, the compact unit comprising a first tube and a second tube, the first tube and the second tube being arranged generally concentrically,
the compact unit defining two medium flow passages that are parallel in relation to each other and that run between an upper side of the piston and a lower side of the piston,
the two medium flow passages communicating with setting devices that are adapted to control flow characteristics through the two medium flow passages in order to adapt the damping characteristics to different types of terrain.

2. The device of claim 1, wherein the first tube is enclosed in the second tube, a tube end is mounted to a first end of the first and second tubes, a head is mounted to a second end of the first and second tubes, the setting devices being positioned in the head and at least a portion of the medium flow passages extending within the head, the medium flow passages being connected to a pressurizing location that is common to both of the medium flow passages and the pressurizing location being pressurized by a pressurizing device.

3. The device of claim 2, wherein the setting devices comprise a first adjustable device and a second adjustable device, the first adjustable device affecting flow in a first passage of the two medium flow passages during compression movements and the second adjustable device affecting flow in a second of the two medium flow passages during return movements such that the first adjustable device and the second adjustable device can be separately adjusted to adjust compression and return characteristics independent of each other.

4. The device of claim 2, wherein the pressurizing device comprises a piston that is pressurized by a pressurizing component selected from the group consisting of a volume of fluid, a spring, an elastic member, and an expandable bellows member.

5. The device of claim 2, wherein the pressurizing device comprises an external container.

6. The device of claim 1, wherein the first tube is enclosed in the second tube, a tube end is mounted to a first end of the first and second tubes, medium flow passages being arranged in an upper part and a lower part of the first tube, the medium flow passages being fluidly connected to a pressurizing location that is common to both of the parallel flow passages, the pressurizing location being pressurized by a pressurizing device.

7. The device of claim 6, wherein the pressurizing device is integrally formed within the removable compact unit.

8. The device of claim 1, wherein the two generally concentric tubes of the removable compact unit can be inserted in the outer leg and a head that is connected to the two generally concentric tubes is mounted on one end of the outer leg.

9. The device of claim 1, wherein the piston rod is sealed against and extends through an end of the two generally concentric tubes of the compact unit.

10. The device of claim 9, wherein one end of the piston rod is attached to a bottom unit, the bottom unit being connected to the inner leg, the piston being attached to a second end of the piston rod, the piston operating within one of the two generally concentric tubes of the removable compact unit.

11. A removable insert device for telescopic fork legs that comprise outer and inner legs and a damping system with a piston and piston rod arrangement arranged within a region defined at least in part by the outer and inner legs, the device comprising:
two generally concentric tubes, a first medium flow passage defined between the two generally concentric tubes;
a second medium flow passage and a third medium flow passage extending in parallel to each other and extending between an upper side of the piston and a lower side of the piston;
the second medium flow passage and the third medium flow passage being fluidly coupled to the first medium flow passage and running parallel in relation to each other, and a pressurizing member in fluid communication with the second and third medium flow passage;
the first and second medium flow passages each comprising flow control devices that are configured to adjust the damping characteristics of the fork legs to different types of terrain.

12. The device of claim 11 in combination with a vehicle.

13. The device of claim 11 in combination with a motorcycle.

14. The device of claim 11, wherein a tube end is mounted to a first end of the two generally concentric tubes and a head is mounted to a second end of the two generally concentric tubes, the head also being coupled to the outer leg of the fork legs.

15. The device of claim 14, wherein the piston rod is sealed against and extends through the tube end.

16. The device of claim 14, wherein a first end of the piston rod is attached to a bottom unit, the bottom unit being connected to the inner leg, the piston being attached to a second end of the piston rod, and the piston being located within and operating within one of the two generally concentric tubes.

17. The device of claim 14, wherein the head encloses a first adjustable flow control valve that defines the flow control device in the first medium flow passage, the head also encloses a second adjustable flow control valve that defines the flow control device in the second medium flow passage, the first and second adjustable flow control valves being adapted for separate adjustment, the first adjustable flow control valve adapted to alter compression characteristics and the second adjustable flow control valve adapted to alter return characteristics.

18. The device of claim 11, wherein the pressurizing member comprises an external container.

19. The device of claim 11, wherein the pressurizing member comprises a piston that is pressurized by a volume of fluid, a spring, an elastic member or an expandable bellows.

20. The device of claim 11, wherein the pressurizing member is integrally formed between the outer leg of the front fork and the removable compact unit.

21. A removable insert device for a telescopic fork leg, the telescopic fork leg comprising an upper fork leg and a lower fork leg, the lower fork leg being slidable relative to the upper fork leg, a bottom unit connected to the lower fork leg, a head unit connected to the upper fork leg, a spring positioned within the lower fork leg, a piston shaft positioned within the lower fork leg, a piston carried on the piston shaft, the piston comprising a first flow opening and a second flow opening, the piston being arranged in a damping cylinder, the piston separating an upper compression chamber from a lower rebound chamber in the damping cylinder, an outer tube arranged concentrically outside the damping cylinder, a cartridge tube positioned within the upper fork leg, the outer tube is secured to the cartridge tube, the cartridge tube at least partially defining a pressurizing device, the pressurizing device being positioned above the damping cylinder, a rebound valve control being mounted in the bottom unit, the rebound valve control being connected to a rebound adjustment shaft, the rebound adjustment shaft extending through a hollow portion of the piston shaft, the adjustment shaft being configured to adjust flow through the first flow opening in the piston, a compression valve control being mounted in the head unit, the compression valve control being connected to a compression adjustment shaft, the compression adjustment shaft being configured to adjust flow through a needle valve that controls flow into the compression chamber.
